(19) United States
(12) Patent Application Publication
(10) Pub. No.: US 2005/0016562 A1
(43) Pub. Date: Jan. 27, 2005

(54) Eye liner pencil

(76) Inventor: Melanie R. Werner, Sewickley, PA (US)

Correspondence Address: Ansel M. Schwartz, Suite 304, 201 N. Craig Street, Pittsburgh, PA, 15312, US

(21) Appl. No.: 10/922,049

(22) Filed: Aug. 19, 2004

Related U.S. Application Data
(63) Continuation-in-part of application No. 10/373,986, filed on Feb. 25, 2003.

(51) Int. Cl. B43K 19/00

(52) U.S. Cl. 132/318

(57) ABSTRACT

An eye liner pencil. The pencil includes an elongate portion which is gripped by the user, the elongate portion having a central axis. The pencil includes a marking portion extending from the elongate portion and in an angular relationship between 5° and 175° with the elongate portion. The marking portion is for marking an eyelid. A lip liner pencil. A method for applying eye liner to an eyelid. A method for applying lip liner to a lip. The pencil can include a plurality of sections.

### FIELD OF THE INVENTION

The present invention relates to an eye liner pencil. More specifically, the present invention relates to an eye liner pencil having a curved tip, or a straight angled tip that is formed from a plurality of sections.

### BACKGROUND OF THE INVENTION

Currently, all eye liners operate in the same manner; that being “color inside wood or plastic wand, straight, pencil-like case. These products are deficient in that they only allow the user to apply the eye liner at an 180° angle. This can be awkward, imprecise and in some cases, unsafe (greater risk of poking eye).

The present invention allows the user to apply the liner at approximately a 90° angle; offering much greater control, precision, improved arm/wrist/hand angle and safety, (less risk of poking eye).

### SUMMARY OF THE INVENTION

The present invention pertains to an eye liner pencil. The pencil comprises an elongate portion which is gripped by the user, the elongate portion having a central axis. The pencil comprises a marking portion extending from the elongate portion and in an angular relationship between 5° and 175° with the elongate portion. The marking portion is for marking an eyelid and/or lower lash line.

The present invention pertains to a lip liner pencil having the same features as described for the eye liner pencil.

The present invention pertains to a method for applying eye liner to an eyelid and/or lower lash line. The method comprises the steps of gripping an elongate portion of an eye liner pencil. The elongate portion has a central axis. There is the step of marking the eyelid with a marking portion of the eye liner pencil which is in an angular relationship of between 5° and 175°, and preferably between 30° and 60°, and more preferably about 45°, with the central axis of the elongate portion.

The present invention pertains to a method for applying lip liner to a lip using the same steps as described above for the eyelid, except it is applied to the lip.

The present invention pertains to an eye liner pencil for an eyelid of a user. The pencil comprises a first section and at least a second section. The first section fits on top of the second section. Each section has an elongate portion which is gripped by a user that has a hollow portion and a hole in communication with the hollow portion at a bottom end of the elongate portion and a central axis; and a marking portion extending from the elongate portion at a top end of the elongate portion at a fixed angular relationship between 5° and 175° with the central axis. The marking portion colors the eyelid. The top end of the elongate portion and the marking end of the second section extends from the elongate portion through the hole into the hollow portion of the elongate portion of the first section and the top end of the elongate portion of the second section friction fitting with the hollow portion of the elongate portion of the first section.

The present invention pertains to a method for coloring an eyelid of a user. The method comprises the steps of coloring the eyelid with a tip of a color tube that extends from a top end of an elongate portion at a fixed angular relationship of between 5° and 175° from a central axis of the elongate portion of a first section of an eye liner pencil. There is the step of separating the first section from a second section of the pencil which has a tip of a color tube that extends from a top end of an elongate portion at a fixed angular relationship of between 5° and 175° from a central axis of the elongate portion of the second section that extends through a hole at a bottom end of the first section into the hollow portion of the first section. There is the step of coloring the eyelid with the tip of the second section.

### BRIEF DESCRIPTION OF THE DRAWINGS

In the accompanying drawings, the preferred embodiment of the invention and preferred methods of practicing the invention are illustrated in which:

FIG. 1 is a schematic representation of an eye liner pencil with a curved tip.

FIG. 2 is a schematic representation of an eye liner pencil with a straight angled tip.

FIG. 3 is a schematic representation of a pencil with a plurality of sections.

FIG. 4 is a schematic representation of a pencil with a plurality of sections.

FIG. 5 is a cross-sectional view of a section.

### DETAILED DESCRIPTION

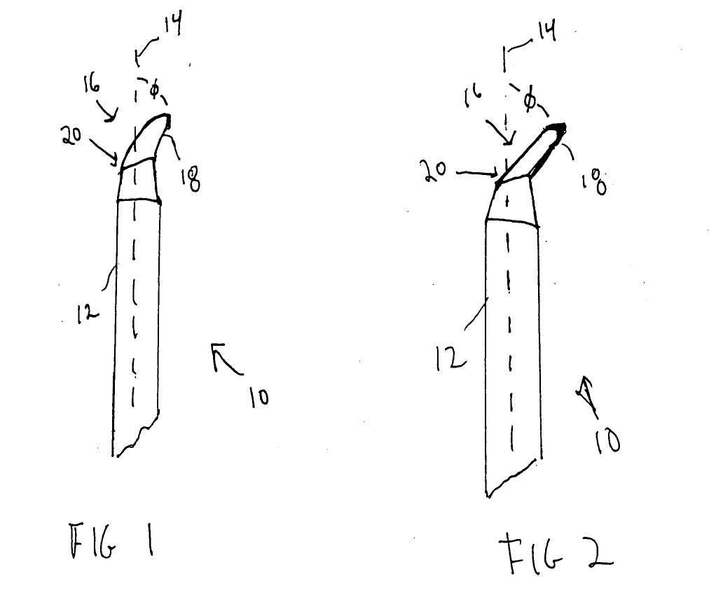

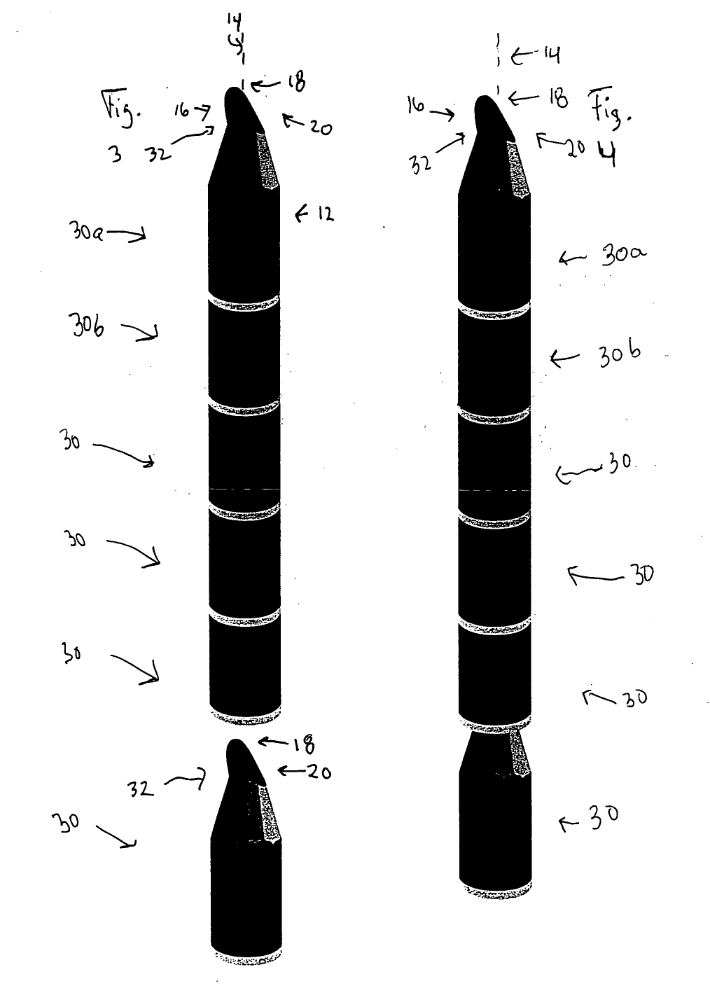

Referring now to the drawings wherein like reference numerals refer to similar or identical parts throughout the several views, and more specifically to FIG. 1 thereof, there is shown an eye liner pencil 10. (Alternatively, it is a lip liner pencil 10.) The pencil 10 comprises an elongate portion 12 having a top end which is gripped by the user, the elongate portion 12 having a central axis 14. The pencil 10 comprises a marking portion 16 extending from the elongate portion 12 and in an angular relationship between 5° and 175°, and preferably between 30° and 60°, and more preferably about 45°, with the central axis 14. The marking portion 16 is for marking an eyelid and/or lower lash line, or lip if it is a lip liner pencil 10 a color. The marking portion 16 is made of the color that is to mark the eyelid. The elongate portion is positioned about the marking portion 16 until a point where the marking portion 16 extends from the elongate portion. Preferably, the marking portion 16 is curved. Alternatively, the marking portion 16 is straight.

The present invention pertains to a method for applying eye liner to an eyelid and/or lower lash line. The method comprises the steps of gripping an elongate portion 12 of an eye liner pencil 10. The elongate portion 12 has a central axis 14. There is the step of marking the eyelid a color with a marking portion 16 of the eye liner pencil 10 that extends from the elongate portion at the top end of the elongate portion at a fixed angular relationship of between 5° and 175°, and preferably about 45°, with the central axis 14 of the elongate portion 12. The marking portion 16 is made of the color that is to mark the eyelid. The elongate portion is positioned about the marking portion 16 until a point where the marking portion 16 extends from the elongate portion. Preferably, the marking portion 16 is curved. Alternatively, the marking portion 16 is straight. The same steps can be used to apply lip liner to a lip, instead of the eye liner to the eyelid.

In the operation of the invention, generally, the eye liner pencil 10 is applied using traditional methods of eye liner application as demonstrated by makeup professionals with one exception; the tip 18 of the eye liner pencil 10 and the hand is positioned at about a 90° angle (versus 180°), allowing greater precision and control of the eye liner pencil 10. This angle also eliminates awkward wrist actions while simultaneously offering greater safety (less risk of poking eye). The same holds true when the eye liner pencil 10 is instead a lip liner pencil 10, and lip liner is applied to the lip.

Most importantly, the angle of the eye liner tip 18 (point) facilitates application of eye liner color, allowing the wearer to place color more smoothly and precisely on the upper lid and the lower lash line; or the lip with the lip liner tip 18.

Description of How to Make the Tip 18:

Fabricate the pencil 10 and insert “color” as usual.
Step 1. Holding the eye liner pencil 10 tip 18 in the DOWNWARD position, pour boiling water to ONE side of the pencil 10 for 15-30 seconds. This process of adding heat gently slowly draws eye liner color out of the tube 20.
   The heating process also creates the wooden (pencil-like) case to form the appropriate angle/edge at the point where the color exits the pencil 10.
Step 2: Immediately after applying (liquid) heat, turn the eye liner tip 18 UPWARDS. Using fingers and hand, apply gentle pressure to the OPPOSITE, unheated side of the wand carefully forming and bending tip 18 to desired angle.
Step 3: Allow eye liner pencil 10 to cool at room temperature.

It should be noted that a cap can be used to be placed over the tip, to protect the tip from damage when the pencil is not in use, as is normally done with traditional eye liner pencils. The above description is also applicable to a lip liner pencil 10.

The present invention pertains to an eye liner pencil 10 for an eyelid of a user. The pencil 10 comprises a first section 30a and at least a second section 30b. The first section 30a fits on top of the second section 30b. Each section 30 has an elongate portion 12 which is gripped by a user that has a hollow portion 34 and a hole 36 in communication with the hollow portion 34 at a bottom end 38 of the elongate portion 12 and a central axis 14; and a marking portion 16 extending from the elongate portion 12 at a top end 32 of the elongate portion 12 at a fixed angular relationship between 5° and 175° with the central axis 14. The marking portion 16 colors the eyelid. The top end 32 of the elongate portion 12 and the marking end of the second section 30b extends from the elongate portion 12 through the hole 36 into the hollow portion 34 of the elongate portion 12 of the first section 30a and the top end 32 of the elongate portion 12 of the second section 30b friction fitting with the hollow portion 34 of the elongate portion 12 of the first section 30a.

Preferably, the marking portion 16 of the first section 30a is a different color from the marking portion 16 of the second section 30b, although all the marking portions 16 of all the sections 30 can be of the same color. The first section 30a is preferably removed from the second section 30b when the marking portion 16 of the first section 30a is worn down. Preferably, the marking portion 16 includes a color tube 20 extending from the elongate portion 12. The tube 20 has a tip 18 that is at a fixed angular relationship of between 5° and 175° with the central axis 14.

The present invention pertains to a method for coloring an eyelid of a user. The method comprises the steps of coloring the eyelid with a tip 18 of a color tube 20 that extends from a top end 32 of an elongate portion 12 at a fixed angular relationship of between 5° and 175° from a central axis 14 of the elongate portion 12 of a first section 30a of an eye liner pencil 10. There is the step of separating the first section 30a from a second section 30b of the pencil 10 which has a tip 18 of a color tube 20 that extends from a top end 32 of an elongate portion 12 at a fixed angular relationship of between 5° and 175° from a central axis 14 of the elongate portion 12 of the second section 30b that extends through a hole 36 at a bottom end 38 of the first section 30a into the hollow portion 34 of the first section 30a. There is the step of coloring the eyelid with the tip 18 of the second section 30b.

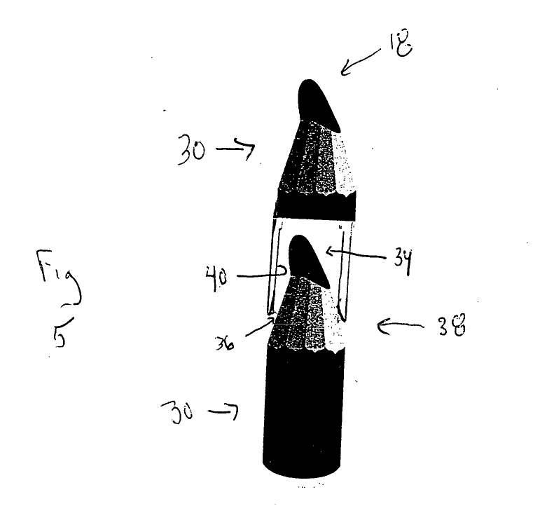

In the operation of the alternative embodiment, and as shown in FIGS. 3-5, an eye liner pencil 10 is used to color the eyelid of a user. The eye liner pencil 10 is formed from a plurality of sections 30. There is a first section 30a having a tip 18 of a color tube 20 that extends from a top end 32 of an elongate portion 12 at a fixed angular relationship of between 5° and 175° from a central axis 14 of the elongate portion 12, preferably on only one side of the central axis 14. The elongate portion 12 has a hollow portion 34 and a hole 36 in communication with the hollow portion 34 at a bottom end 38 of the elongate portion 12. The user grips the elongate portion 12 to hold the pencil 10 as color is applied to the eyelids of the user. As explained above, because of the angular relationship of the tip 18, it facilitates the application of color to the eyelids.

There is a second section 30b of the pencil 10 which has a tip 18 of a color tube 20 that extends from a top end 32 of an elongate portion 12 at a fixed angular relationship of between 5° and 175° from a central axis 14 of the elongate portion 12 of the second section 30b. The elongate portion 12 of the second section 30b also has a hollow portion 34 and a hole 36 in communication with the hollow portion 34 at a bottom and of the elongate portion 12 of the second section 30b. The top end 32 of the elongate portion 12 of the second section 30b and the tip 18 of the second section 30b extends through the hole 36 of the first section 30a into the hollow portion 34 of the elongate portion 12 of the first section 30a and the elongate portion 12 of the second section 30b friction fits with the inner surface 40 of the hollow portion 34.

When the tip 18 of the first section 30a is worn down, or, if the second section 30b, or additional sections 30 below the second section 30b have a tip 18 of a color that is more desirable than the color of the tip 18 of the first section 30a, the first section 30a is separated from the second section 30b, and the tip 18 of the second section 30b is then used to color the eyelid of the user. That is, each section 30 can have a different color tube 20. If it so happens that the tip 18 of a desired color is in a section 30 below the second section 30b, then the desired section 30 is separated from the other sections 30, and placed on top of the first section 30a through its hollow portion 34, and the section 30 having a tip 18 with the desired color is used to color the eyelid of the user. The tip 18 at the fixed angular relationship of between 5° and 175° from the central axis 14 of the elongate portion 12 is formed as explained above.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. An eye liner pencil for an eyelid of a user comprising:
a first section and at least a second section, the first section fits on top of the second section, each section having an elongate portion which is gripped by a user that has a hollow portion and a hole in communication with the hollow portion at a bottom end of the elongate portion, and a central axis; and a marking portion extending from the elongate portion at a top end of the elongate portion at a fixed angular relationship between 5° and 175° with the central axis, the marking portion coloring the eyelid, the top end of the elongate portion and the marking end of the second section extending from the elongate portion through the hole into the hollow portion of the elongate portion of the first section and the top end of the elongate portion of the second section friction fitting with the hollow portion of the elongate portion of the first section.

2. A pencil as described in claim 1 wherein the marking portion of the first section is a different color from the marking portion of the second section.

3. A pencil as described in claim 1 wherein the first section is removed from the second section marking portion of the first section is worn down.

4. A pencil as described in claim 3 wherein the marking portion includes a color tube extending from the elongate portion, the tube having a tip that is at a fixed angular relationship of between 5° and 175° with the central axis.

5. A method for coloring an eyelid of a user comprising the steps of:
coloring the eyelid with a tip of a color tube that extends from a top end of an elongate portion at a fixed angular relationship of between 5° and 175° from a central axis of the elongate portion of a first section of an eye liner pencil;
separating the first section from a second section of the pencil which has a tip of a color tube that extends from a top end of an elongate portion at a fixed angular relationship of between 5° and 175° from a central axis of the elongate portion of the second section that extends through a hole at a bottom end of the first section into the hollow portion of the first section; and
coloring the eyelid with the tip of the second section.
